(19) United States
(12) Patent Application Publication
(10) Pub. No.: US 2025/0252137 A1
(43) Pub. Date: Aug. 7, 2025

(54) Zero-Shot Multi-Modal Data Processing Via Structured Inter-Model Communication

(71) Applicant: Google LLC, Mountain View, CA (US)

(72) Inventors: Andy Zeng, New York, NY (US); Adrian Wing Dak Wong, Saratoga, CA (US); Stefan Welker, Berlin (DE); Krzysztof Choromanski, Lincroft, NJ (US); Federico Tombari, Zug (CH); Aveek Ravishekhar Purohit, Palo Alto, CA (US); Michael Sahngwon Ryoo, Rocky Point, NY (US); Vikas Sindhwani, Mt. Kisco, NY (US); Johnny Chung Lee, Redmond, WA (US); Vincent Olivier Vanhoucke, San Francisco, CA (US); Peter Raymond Florence, San Francisco, CA (US)

(21) Appl. No.: 18/853,065

(22) PCT Filed: Mar. 31, 2023
(86) PCT No.: PCT/US2023/017188

§ 371 Date: Sep. 30, 2024

Related U.S. Application Data
(60) Provisional application No. 63/326,643, filed on Apr. 1, 2022.

(51) Int. Cl. G06F 16/903; G06F 9/54; G06F 40/30

(52) U.S. Cl. CPC G06F 16/90335; G06F 9/546; G06F 40/30

(57) ABSTRACT

Systems and methods of the present disclosure are directed to computer-implemented method for contextual processing via inter-model between pre-trained machine-learned models. The method includes obtaining, by a computing system comprising one or more computing devices, input data. The method includes processing, by the computing system, the input data with two or more pre-trained models to generate output data, wherein processing the input comprises executing a structured inter-model communication schema for inter-model communication between the two or more pre-trained models over a communications channel. The method includes providing, by the computing system, the output data as an output.

### PRIORITY CLAIM

The present application is based on and claims priority to U.S. Provisional Application 63/326,643 having a filing date of Apr. 1, 2022, which is incorporated by reference herein.

### FIELD

present disclosure relates generally to structured inter-model communication for machine-learned models. More particularly, the present disclosure relates to contextual processing of multi-modal data via structured inter-model communication between foundation machine-learned models.

### BACKGROUND

Foundation models are models trained on broad data at scale and are adaptable to a wide variety of downstream tasks (e.g., visual-language models (VLMs), large language models (LMs), audio-language models (ALMs), etc.). Recently, foundation models have enabled impressive capabilities for various machine learning tasks. However, these capabilities depend on the distribution of training data, which is generally considerably different across domains. For example, VLMs are generally trained on image and video captions, while LMs are additionally trained on a large corpora of other data (e.g., spreadsheets, fictional novels, standardized test questions, etc.).

### SUMMARY

Aspects and advantages of embodiments of the present disclosure will be set forth in part in the following description, or can be learned from the description, or can be learned through practice of the embodiments.

One example aspect of the present disclosure is directed to computer-implemented method for contextual processing via inter-model communication between machine-learned models. The method includes obtaining, by a computing system comprising one or more computing devices, input data. The method includes processing, by the computing system, the input data with two or more pre-trained models to generate output data, wherein processing the input comprises executing a structured inter-model communication schema between the two or more pre-trained models. The method includes providing, by the computing system, the output data as an output.

Another example aspect of the present disclosure is directed to computing system for contextual processing with foundation machine-learned models. The computing system includes one or more processors. The computing system includes one or more non-transitory computer-readable media that collectively store instructions that, when executed by the one or more processors, cause the computing system to perform operations. The operations include obtaining input data. The operations include processing the input data with two or more pre-trained models to generate output data, wherein processing the input comprises executing a structured inter-model communication schema between the two or more pre-trained models. The operations include providing the output data as an output.

Another example aspect of the present disclosure is directed to one or more non-transitory computer-readable media that collectively store instructions that, when executed by one or more computing devices, cause the one or more computing devices to perform operations. The operations include obtaining input data. The operations include processing the input data with two or more pre-trained models to generate output data, wherein processing the input comprises executing a structured inter-model communication schema structured dialog between the two or more pre-trained models. The operations include providing the output data as an output.

Another example aspect of the present disclosure is directed to a method for contextual processing via structured inter-model communication between machine-learned models. The method includes obtaining, by a computing system comprising one or more computing devices, input data and a corpus of context data, wherein the input data comprises data descriptive of a query, and wherein the corpus of context data comprises multimodal data. The method includes processing, by the computing system, the corpus of context data with one or more of the two or more pretrained models to obtain a language-based context history, wherein the one or more pre-trained models comprises a language model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

Figure TA depicts a block diagram of an example computing system that performs contextual processing via structured inter-model communication between pre-trained machine-learned models according to example embodiments of the present disclosure.

FIG. 1B depicts a block diagram of an example computing device that performs contextual processing via structured inter-model communication between pre-trained machine-learned models according to example embodiments of the present disclosure.

FIG. 1C depicts a block diagram of an example computing device that performs contextual processing via structured inter-model communication between pre-trained machine-learned models according to example embodiments of the present disclosure.

FIG. 2 depicts a block diagram of example pre-trained models and an associated structured inter-model communication schema according to example embodiments of the present disclosure.

Reference numerals that are repeated across plural figures are intended to identify the same features in various implementations.

### DETAILED DESCRIPTION

### Overview

Generally, the present disclosure is directed to contextual zero-shot processing via structured inter-model communication between machine-learned models (e.g., foundation models). More specifically, recent advances in machine learning have led to the creation of large models that are capable of performing a wide variety of downstream zero-shot tasks (i.e., “foundation models”). The present disclosure uses structured (i.e., Socratic) inter-model communication schemas to leverage complementary differences between existing, pre-trained foundation models to perform new tasks without any additional training or fine-tuning.

Specifically, structured inter-model communication can be utilized to guide the exchange between foundational models, and therefore exploit their zero-shot capabilities. A structured inter-model communication schema can be executed to process input data with two or more pre-trained models and generate output data (e.g., video data, textual data, etc.). As an example, the structured inter-model communication schema may instruct a pre-trained language model is to process a query input from a user (e.g., “where is the remote”) to obtain a prompt (e.g., “remote”). The structured inter-model communication schema may then instruct a pre-trained visual language model to process the prompt to obtain a series of key frames from first-person video data collected by the user (e.g., frames that depict the last known location of the remote). In such fashion, the complementary zero-shot capabilities of multiple foundational models can be leveraged to perform new and increasingly complex tasks without any additional training or fine-tuning.

Embodiments of the present disclosure provide a number of technical effects and benefits. As one example technical effect and benefit, by leveraging complementary capabilities of foundational models via structured inter-model communication, embodiments of the present disclosure provide a significant improvement in various machine-learning use cases in comparison to conventional techniques (e.g., question/answer tasks, video understanding tasks, forecasting tasks, etc.). As another example technical effect and benefit, foundation models are very large models that require substantial resources to train, re-train or otherwise optimize. By obviating the need to re-train or fine-tune any existing pre-trained models, embodiments of the present disclosure eliminate the substantial computational resources associated with re-training which would be required using conventional techniques (e.g., computation cycles, memory, power, storage, hardware, etc.).

With reference now to the Figures, example embodiments of the present disclosure will be discussed in further detail.

### Example Devices and Systems

Figure TA depicts a block diagram of an example computing system that performs contextual processing via structured inter-model communication between pre-trained machine-learned models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more pre-trained foundation models 120 (e.g., a large language model, a visual language model, an audio language model, etc.). For example, the pre-trained foundation models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example pre-trained foundation models 120 are discussed with reference to FIG. 4. It should be noted that although the present disclosure is described with regards to foundation models, foundation models are not necessary for utilization of the present disclosure. Rather, in some embodiments, non-foundation model(s) may be substituted for foundation model(s).

In some implementations, the one or more pre-trained foundation models 120 can be received from the server computing system 130 over network 180, stored in the user computing device memory 114, and then used or otherwise implemented by the one or more processors 112. In some implementations, the user computing device 102 can implement multiple parallel instances of a single pre-trained foundation model 120 (e.g., to perform parallel contextual processing across multiple instances of the foundation models 120).

More particularly, the pre-trained foundation machine-learned models 120 can be utilized via structured inter-model communication (e.g., e.g., using a schema and communication over a communications channel) to perform contextual processing (e.g., zero-shot processing) that enables the performance of previously-untrained tasks without any additional training of the models. For example, the user computing device 102 can obtain input data that includes data indicative of a query (e.g., via user input component 122) and multimodal data (e.g., video data, audio data, textual data, etc.) (e.g., via sensor(s) of the device 102, etc.). The user computing device 102 can execute a structured inter-model communication schema for inter-model communication between two pre-trained models 120 via a communications channel to process the input data, thereby generating output data. The output data can be provided by the user computing device 102 as an output (e.g., to a user of the user computing device 102, etc.).

As an example, the pre-trained foundation machine-learned models 120 may include a language model and a visual language model. To execute the structured inter-model communication schema, the user computing device 102 may process data descriptive of a query (e.g., textual input data, etc.) with a model of the pre-trained models 102 (e.g., a language model, etc.) to obtain a prompt associated with the query. The user computing device 102 can process the prompt with a visual language model of the two or more pretrained models 102 to obtain output data that includes one or more video frames associated with the prompt. For a specific example, the query may ask “when did I last see my remote control”, and the multimodal data may include video data recorded from the user computing device 102 or transmitted to the user device that captures a first-person view from the user over a period of time. The language model may process the query to obtain a prompt that includes “remote control.” The “remote control” prompt may be processed using the visual language model to obtain the output data, which may include one or more video frames that depict the remote control at the last time(s) it was seen. In such fashion, structured inter-model communication can occur over a communications channel to provide contextual processing, therefore providing the user computing device 102 with the capacity to perform additional tasks without utilizing additional resources to further train the pre-trained models 120.

Additionally or alternatively, one or more pre-trained foundation models 140 can be included in or otherwise stored and implemented by the server computing system 130 that communicates with the user computing device 102 according to a client-server relationship. For example, the pre-trained foundation models 140 can be implemented by the server computing system 140 as a portion of a web service (e.g., a contextual processing (e.g., zero-shot processing) service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more pre-trained foundation models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 4.

Optionally, the user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

Optionally, the training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

However, it should be noted that embodiments of the present disclosure provide the pre-trained models 120 with the capacity to perform previously-untrained tasks without utilization of additional training via the training computing system or any other system. As such, some embodiments of the present disclosure may obviate the need to utilize the training computing system 150 and any other training systems or techniques.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

Figure TA illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

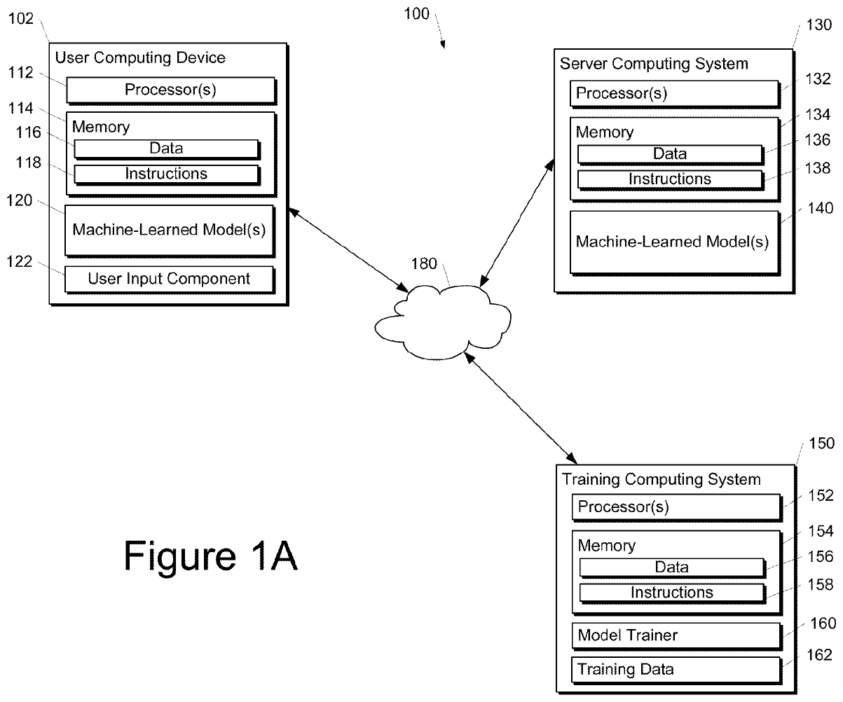

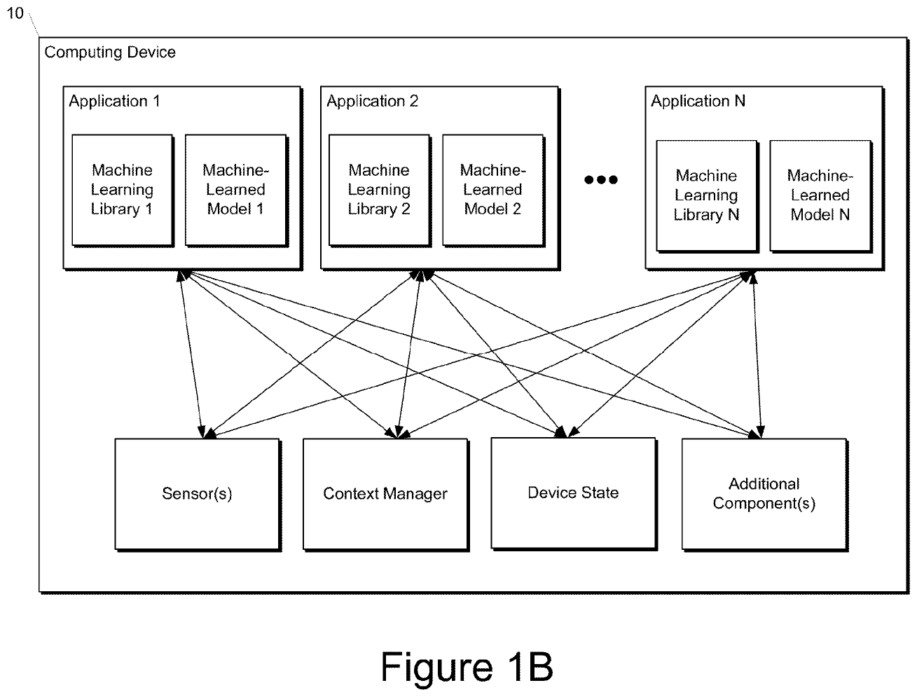

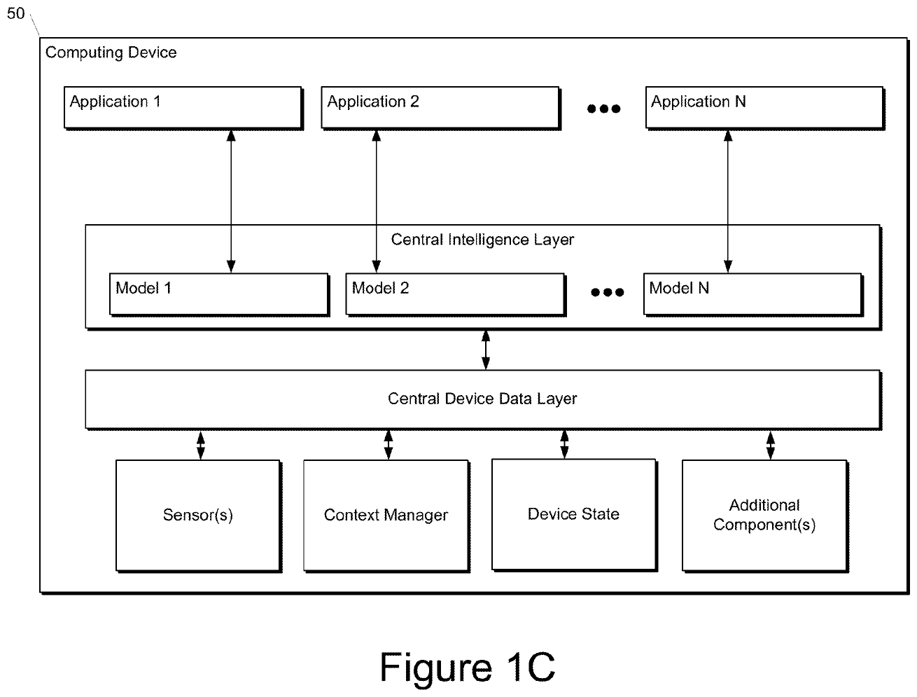

FIG. 1B depicts a block diagram of an example computing device that performs contextual processing via structured inter-model communication between pre-trained machine-learned models according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that performs contextual processing via structured inter-model communication between pre-trained machine-learned models according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

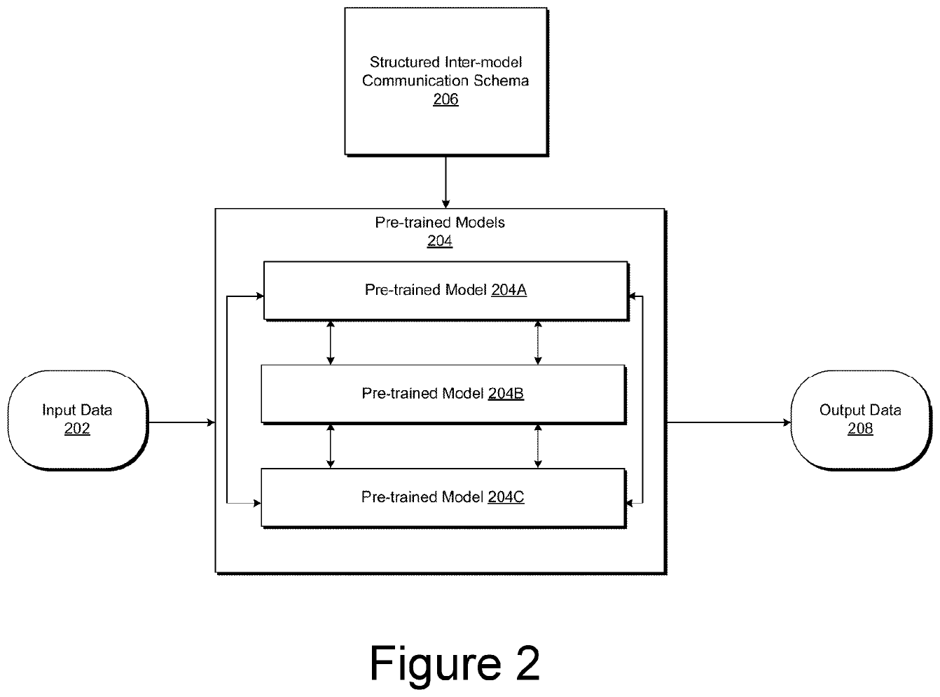

FIG. 2 depicts a block diagram of example pre-trained models and an associated structured inter-model communication schema according to example embodiments of the present disclosure. More specifically, a computing system (e.g., computing system 130 of FIG. 1, etc.) can execute structured inter-model communication schema 206 to process the input data 202 with pre-trained models 204 (e.g., pre-trained models 204A-204C) to obtain output data 208. For example, the input data 202 may include data indicative of a query (e.g., from a user, etc.) and multimodal data (e.g., video data, audio data, textual data, etc.). The pre-trained machine-learned models 204 may include a language model and a visual language model. To execute the structured inter-model communication schema 206, the data descriptive of a query in the input data 202 can be processed with a model of the pre-trained models 204 (e.g., a language model, etc.) to obtain a prompt associated with the query. The prompt can be processed with a visual language model of the pretrained models 204 to obtain the output data 208 that includes one or more video frames associated with the prompt.

For a specific example, the query in the input data 202 may ask “when did I last see my remote control”, and the multimodal data may include video data recorded from the user computing device 102 or transmitted to the user device that captures a first-person view from the user over a period of time. A language model (e.g., pre-trained model 204A) may process the query to obtain a prompt that includes “remote control.” The “remote control” prompt may be processed using a visual language model (e.g., 204B) to obtain the output data 208, which may include one or more video frames that depict the remote control at the last time(s) it was seen.

The structured inter-model communication schema 206 can be, or otherwise include, a series of instructions that indicates an order in which the pre-trained models 204A-204C are to process various the input data 202, various intermediary inputs/outputs, and the output data 208. To follow the previous example, the structured inter-model communication schema 206 may instruct the pre-trained language model 204A to first process the query in the input data 202 to obtain the prompt (e.g., an intermediate input/output). The structured inter-model communication schema 206 may then instruct the pre-trained visual language model 204B to process the prompt and the multimodal data of the input data 202 to obtain the output data 208 (e.g., retrieving key frames in response to the prompt, etc.). Alternatively, in some embodiments, the structured inter-model communication schema 206 may determine that the user desires a description, rather than an image, and may instruct the pre-trained visual language model to process the key frames to obtain a description of each key frame. Next, the structured inter-model communication schema 206 may instruct the language model 204A to process the descriptions of each key frame to generate the output data 208, which can include a contextual answer to the users query.

As such, the structured inter-model communication schema 206 can determine the flow and operation of the pre-trained models 204 based on the content of the input data 202. Additionally, in some embodiments, the structured inter-model communication schema 206 can provide structured prompts to the pre-trained models 204 to further optimize the performance of the pre-trained models 204.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for contextual processing via structured inter-model communication between machine-learned models, the method comprising:
obtaining, by a computing system comprising one or more computing devices, input data;
processing, by the computing system, the input data with two or more pre-trained models to generate output data, wherein processing the input comprises executing a structured inter-model communication schema for inter-model communication between the two or more pre-trained models over a communications channel; and
providing, by the computing system, the output data as an output.

2. The computer-implemented method of claim 1, wherein the method further comprises:
receiving, by the computing system, a corpus of context data; and
processing, by the computing system, the corpus of context data with one or more of the two or more pre-trained models to obtain a language-based context history, wherein the one or more pre-trained models comprises a pre-trained language model.

3. The computer-implemented method of claim 2, wherein the corpus of context data comprises multi-modal data comprising video data, audio data, and/or textual data.

4. The computer-implemented method of claim 1, wherein the two or more pre-trained models comprise two or more of:
a pre-trained language model;
a pre-trained visual language model; or
a pre-trained audio language model.

5. The computer-implemented method of claim 1, wherein:
the input data comprises multi-modal data comprising video data and data descriptive of a query; and
executing the structured inter-model communication schema between the two or more pre-trained models comprises:
processing, by the computing system, the data descriptive of the query with a pre-trained model of the two or more pretrained models to obtain a prompt associated with the query; and
processing, by the computing system, the prompt associated with the query with a pre-trained visual language model of the two or more pre-trained models to obtain output data comprising one or more video frames associated with the prompt.

6. The computer-implemented method of claim 5, wherein:
the data descriptive of the query comprises audio data or textual data; and
the model of the two or more pre-trained models comprises a pre-trained language model or a pre-trained audio language model.

7. The computer-implemented method of claim 4, wherein the input data comprises multi-modal data comprising video data; and
executing the structured inter-model communication schema between the two or more pre-trained models comprises, for one or more iterations:
providing, by the computing system, one or more structured prompts to a pre-trained visual language model of the two or more pre-trained models to obtain data descriptive of one or more key frames of the video data; and
processing, by the computing system, the data descriptive of the one or more key frames with a pre-trained language model of the two or more pre-trained models to obtain a natural language summary of the one or more key frames of the video data and the one or more structured prompts.

8. The computer-implemented method of claim 7, wherein:
the multimodal data further comprises textual data descriptive of a query; and
executing the structured inter-model communication schema between the two or more pre-trained models comprises:
determining, by the computing system, a language-based context history based at least in part on one or more natural language summaries from the one or more respective iterations; and
processing, by the computing system, the language-based context history and the textual data with the pre-trained language model of the two or more pre-trained models to obtain output data descriptive of an answer to the query.

9. The computer-implemented method of claim 1, wherein the output comprises a zero-shot processing output.

10. A computing system for contextual processing via inter-model communication between pre-trained machine-learned models, the computing system comprising:
one or more processors; and
one or more non-transitory computer-readable media that collectively store instructions that, when executed by the one or more processors, cause the computing system to perform operations, the operations comprising:
obtaining input data;
processing the input data with two or more pre-trained models to generate output data, wherein processing the input comprises executing a structured inter-model communication schema for inter-model communication between the two or more pre-trained models over a communications channel; and
providing the output data as an output.

11. One or more non-transitory computer-readable media that collectively store instructions that, when executed by one or more computing devices, cause the one or more computing devices to perform operations, the operations comprising:
obtaining input data;
processing the input data with two or more pre-trained models to generate output data, wherein processing the input comprises executing a structured inter-model communication schema for inter-model communication between the two or more pre-trained models over a communications channel;
providing the output data as an output;
receiving a corpus of context data;
processing the corpus of context data with one or more of the two or more pre-trained models to obtain a language-based context history, wherein the one or more pre-trained models comprise a pre-trained language model.

12. The one or more non-transitory computer-readable media of claim 11, wherein the corpus of context data comprises multi-modal data comprising video data, audio data, and/or textual data.

13. The one or more non-transitory computer-readable media of claim 11, wherein the two or more pre-trained models comprise two or more of:
a pre-trained language model;
a pre-trained visual language model; or
a pre-trained audio language model.

14. The one or more non-transitory computer-readable media of claim 11, wherein:
the input data comprises multi-modal data comprising video data and data descriptive of a query; and
executing the structured inter-model communication schema between the two or more pre-trained models comprises:
processing the data descriptive of the query with a pre-trained model of the two or more pretrained models to obtain a prompt associated with the query; and
processing the prompt associated with the query with a pre-trained visual language model of the two or more pre-trained models to obtain output data comprising one or more video frames associated with the prompt.

15. The one or more non-transitory computer-readable media of claim 14, wherein:
the data descriptive of the query comprises audio data or textual data; and
the model of the two or more pre-trained models comprises a pre-trained language model or a pre-trained audio language model.

16. The one or more non-transitory computer-readable media of claim 13, wherein the input data comprises multi-modal data comprising video data; and
executing the structured inter-model communication schema between the two or more pre-trained models comprises, for one or more iterations:
providing one or more structured prompts to a pre-trained visual language model of the two or more pre-trained models to obtain data descriptive of one or more key frames of the video data; and
processing the data descriptive of the one or more key frames with a pre-trained language model of the two or more pre-trained models to obtain a natural language summary of the one or more key frames of the video data and the one or more structured prompts.

17. The one or more non-transitory computer-readable media of claim 16, wherein:
the multimodal data further comprises textual data descriptive of a query; and
executing the structured inter-model communication schema between the two or more pre-trained models comprises:
determining, by the computing system, a language-based context history based at least in part on one or more natural language summaries from the one or more respective iterations; and
processing, by the computing system, the language-based context history and the textual data with the pre-trained language model of the two or more pre-trained models to obtain output data descriptive of an answer to the query.

18. The one or more non-transitory computer-readable media of claim 11, wherein the output comprises a zero-shot processing output.

19. A method for Socratic contextual processing via inter-model communication between pre-trained machine-learned models, the method comprising:
obtaining, by a computing system comprising one or more computing devices, input data and a corpus of context data, wherein the input data comprises data descriptive of a query, and wherein the corpus of context data comprises multimodal data comprising two or more of video data, audio data, or textual data;
processing, by the computing system, the corpus of context data with one or more of the two or more pre-trained models to obtain a language-based context history, wherein the one or more pre-trained models comprises a language model; and
processing, by the computing system, the language-based context history and the data descriptive of the query with the pre-trained language model of the two or more pre-trained models to obtain output data descriptive of an answer to the query.

20. The method of claim 19, wherein the corpus of context data comprises video data and corresponding audio data;
wherein processing, by the computing system, the corpus of context data with the one or more of the two or more pre-trained models comprises processing, by the computing system, the video data with a pre-trained visual language model of the one or more pre-trained models to obtain data descriptive of a plurality of key frames of the video data; and
processing, by the computing system, the data descriptive of the plurality of key frames of the video data with the pre-trained language model of the one or more pre-trained models to obtain the language-based context history.
